(19) United States
(12) Patent Application Publication
(10) Pub. No.: US 2026/0291074 A1
(43) Pub. Date: Sep. 24, 2026

(54) LOW ELEVATION ANGLE NULLING ANTENNA METHODS AND SYSTEMS

(71) Applicant: CALIAN GNSS LTD., OTTAWA (CA)

(72) Inventors: JOSEPH BOTROS, OTTAWA (CA); JULIEN HAUTCOEUR, GATINEAU (CA); GYLES PANTHER, OTTAWA (CA)

(21) Appl. No.: 19/479,330

(22) PCT Filed: Apr. 12, 2024
(86) PCT No.: PCT/CA2024/050479

§ 371 Date: Oct. 27, 2025

Related U.S. Application Data
(60) Provisional application No. 63/499,088, filed on Apr. 28, 2023.

(51) Int. Cl. H01Q 11/08; G01S 19/22; G01S 19/36; H01Q 5/335; H01Q 21/26; H01Q 21/30

(52) U.S. Cl. CPC H01Q 11/08; G01S 19/22; G01S 19/36; H01Q 5/335; H01Q 21/26; H01Q 21/30

(57) ABSTRACT

Global navigation satellite systems (GNSS) employ a network of geo-spatially positioned satellites to broadcast precisely synchronized navigation messages, thereby providing for determination of a network time and a geolocation by dedicated GNSS receivers. However, such GNSS antennas are susceptible to interference incident along the direction of the horizon. Reducing antenna susceptibility is typically achieved by implementing an antenna with reduced or null gain at low elevations. However, such designs are narrowband whilst GNSS antennas should operate broadband, e.g. on multiple GNSS bands. Accordingly, broadband antenna designs with reduced or null gain at low elevations are provided.

### CROSS-REFERENCE TO RELATED APPLICATIONS

This patent claims the benefit of priority to U.S. Provisional Patent Application 63/499,088 filed Apr. 28, 2023.

### FIELD OF THE INVENTION

This patent application relates to low elevation angle nulling antennas, methods of implementing low elevation angle nulling antennas with quadrifilar antenna elements, assembling flexible substrate antennas and methods of assembling flexible substrate antennas.

### BACKGROUND OF THE INVENTION

Global satellite navigation systems or global navigation satellite systems (GNSS) employ a network of geo-spatially positioned satellites to broadcast precisely synchronized navigation messages, thereby providing for determination of a network time and a geolocation by dedicated GNSS receivers. Such receivers provide for a ubiquitous and global time reference, in addition to a host of geolocation uses, ranging from consumer navigation devices to means to monitor global warming to precision agriculture and of course, military applications.

However, such GNSS antennas are susceptible to interference incident along the direction of the horizon. Accordingly, it would be beneficial to provide a means of implementing a GNSS antenna which has reduced or null gain at low elevations, commonly referred to as low elevation angle nulling antennas (LEANAs). However, prior art LEANA designs are narrowband, whilst GNSS antennas should operate over broadband, e.g. on multiple GNSS bands.

Accordingly, it would be beneficial to provide methods of implementing LEANA devices and systems that allow for broadband operation and high yield.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to low elevation angle nulling antennas, methods of implementing low elevation angle nulling antennas with quadrifilar antenna elements, assembling flexible substrate antennas and methods of assembling flexible substrate antennas.

In accordance with an embodiment of the invention there is provided a method comprising:
providing an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
providing the lower antenna element for the one of the receiving and transmitting another circularly polarized wireless signal within the predetermined frequency range, the lower antenna element comprising a second electrical interface which is coupled to the circuit via another electrical path; and
a phase circuit disposed within the another electrical path between the lower antenna element and the circuit; wherein
the circularly polarized wireless signal and another circularly polarized wireless signal are out of phase by 180° such that the antenna exhibits a maximum gain along the common axis and a minimum gain orthogonal to the common axis;
the phase circuit in combination with the another electrical path between the circuit and the lower antenna provides a phase change versus frequency at the second electrical interface equal to another phase change versus frequency at the first electrical interface; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

In accordance with an embodiment of the invention there is provided an antenna comprising:
an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
the lower antenna element for the one of the receiving and transmitting another circularly polarized wireless signal within the predetermined frequency range, the lower antenna element comprising a second electrical interface which is coupled to the circuit via another electrical path; and
a phase circuit disposed within the another electrical path between the lower antenna element and the circuit; wherein
the circularly polarized wireless signal and another circularly polarized wireless signal operate in conjunction with each other such that the antenna exhibits a maximum gain along the common axis and a minimum gain orthogonal to the common axis;
the phase circuit in combination with the another electrical path between the circuit and the lower antenna provides a phase change versus frequency at the second electrical interface equal to another phase change versus frequency at the first electrical interface; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

In accordance with an embodiment of the invention there is provided an antenna comprising:
an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
the lower antenna element for the one of the receiving and transmitting another circularly polarized wireless signal within the predetermined frequency range, the lower antenna element comprising a second electrical interface which is coupled to the circuit via another electrical path; and
a phase circuit disposed within the electrical path between the upper antenna element and the circuit; wherein
the circularly polarized wireless signal and another circularly polarized wireless signal operate in conjunction with each other such that the antenna exhibits a maximum gain along the common axis and a minimum gain orthogonal to the common axis;
the phase circuit in combination with the electrical path between the circuit and the upper antenna provides a phase change versus frequency at the first electrical interface equal to another phase change versus frequency at the second electrical interface; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

In accordance with an embodiment of the invention there is provided an antenna comprising:
an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
the lower antenna element for the one of the receiving and transmitting another circularly polarized wireless signal within the predetermined frequency range, the lower antenna element comprising a second electrical interface which is coupled to the circuit via another electrical path; and
a first phase circuit disposed within the electrical path between the upper antenna element and the circuit; and
a second phase circuit disposed within the another electrical path between the lower antenna element and the circuit; wherein
the circularly polarized wireless signal and another circularly polarized wireless signal operate in conjunction with each other such that the antenna exhibits a maximum gain along the common axis and a minimum gain orthogonal to the common axis;
the first phase circuit in combination with the electrical path between the circuit and the upper antenna provides a phase change versus frequency at the first electrical interface that is equivalent to another phase change versus frequency at the second electrical interface established by the second phase circuit in combination with the another electrical path; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts an array pattern of two isotropic elements fed 180° out of phase with half wavelength spacing for implementing a low elevation angle nulling antenna (LEANA) devices;

FIG. 2 depicts an exemplary LEANA using a stacked pair of quadrifilar helix antenna elements;

FIG. 3A depicts a LEANA system according to an embodiment of the invention comprising a stacked pair of quadrifilar helix antenna elements and phase compensation circuit;

FIG. 3B depicts a phase diagram of the system according to an embodiment of the invention depicted in FIG. 3A for visualizing the rotation applied between the stacked pair of quadrifilar helix antenna elements;

FIG. 4 depicts a 3-section Pi network representation of a transmission line;

FIG. 5 depicts the 3-section Pi network of FIG. 4 by combining capacitors to simplify the circuit;

FIG. 6 depicts the phase versus frequency response difference between the upper and lower antenna elements of a LEANA according to the embodiment of the invention in FIG. 5;

FIG. 7 depicts orthogonal dipole elements and support carriers for a GNSS antenna without the lower ground plane/support and flexible substrate antenna petals according to the prior art of U.S. 2022/0,344,823;

FIGS. 8 and 9 depict an assembled antenna according to the prior art of U.S. 2022/0,344,823 depicting the lower ground plane/support and flexible substrate antenna petals;

FIG. 10 depicts an assembled antenna using mechanical interfaces for reducing assembly complexity of flexible substrate antenna petals with support carriers or dipole elements according to an embodiment of the invention; and

FIG. 11 depicts the antenna depicted in FIG. 10 partly assembled depicting the mechanical interfaces for reducing assembly complexity of flexible substrate antenna petals with support carriers or dipole elements according to the embodiment of the invention.

### DETAILED DESCRIPTION

The present invention is directed to low elevation angle nulling antennas, methods of implementing low elevation angle nulling antennas with quadrifilar antenna elements, assembling flexible substrate antennas and methods of assembling flexible substrate antennas.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purposes only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps, or integers. Likewise, the phrase “consisting essentially of”, and grammatical variants thereof, when used herein is not to be construed as excluding additional components, steps, features integers or groups thereof but rather that the additional features, integers, steps, components or groups thereof do not materially alter the basic and novel characteristics of the claimed composition, device or method. If the specification or claims refer to “an additional” element, that does not preclude there being more than one of the additional element.

Reference to terms such as “perpendicular”, “along”, “parallel” and grammatical variants thereof in respect to alignment and/or direction should be considered not as absolute but as having a tolerance to variation thereof such that these directions and/or alignments are “substantially” as indicated. Tolerances to these being as established, for example, through manufacturing tolerances, performance tolerances, manufacturing costs etc.

“Azimuth angle” as used herein refers to a rotation angle in the X-Y plane centered on the origin, and relative to a defined direction.

“Elevation angle” or “altitude” as used herein refers to the angle subtended between the Poynting vector of the incident plane wave, and the X-Y (ground) plane. Accordingly, a wave of grazing incidence from the horizon has a near zero elevation angle whilst a wave incident vertically has a 90 degree elevation angle.

“Axial ratio” as used herein refers to a measure of the extent to which an antenna is able to reject circularly polarized signals of the unwanted polarization (a second rotational sense) relative to the wanted polarization (a first rotational sense), and is a measure of the ability to reject multipath signals which is an important parameter for precision antennas.

“Phase center offset” as used herein refers to a concept that there is a region associated with an antenna which tends to a point for a perfect antenna, from within which or at, all signals may be considered to have been received at or transmitted from. This is a virtual region/point in space typically centered just above the midpoint of the physical antenna and is a measure of the limits of knowledge of an antenna's position in space.

“Phase center variation” as used herein refers to a measure of the apparent phase center movement over all incident angles for plane waves (i.e. around all azimuths and all elevation angles) and over all frequencies in the bandwidth. An ideal antenna having a phase center variation of zero.

A “petal” as used herein refers to a metallized antenna structure either free-standing, supported by a frame, patterned onto a substrate, or patented onto a substrate or carrier supported by a frame which provides a receiving antenna element for a GNSS antenna. For simplicity within the following mechanical description of GNSS antennae according to embodiments of the invention the term petal refers to the metallized antenna structure and any substrate or carrier together with ancillary elements for mechanical attachment/retention of the petal discretely or in an array of petals with one or more other elements of the GNSS antenna. Within the following functional description of GNSS antennae according to embodiments of the invention the term petal refers to the metallized antenna structure.

A “dipole antenna” (commonly referred to as a dipole) as used herein refers to, but is not limited to, any one of a class of antennas producing a radiation pattern approximating that of an elementary electric dipole with a radiating structure supporting a line current so energized that the current has only one node at each end.

### Multi-Band Low Elevation Angle Nulling Antenna Design

GNSS receivers are employed within a wide range of applications within both the civil and military markets. One such dominant configuration is dual band receivers for civilian applications employing the L1+L2 bands of the GPS system (formerly Navstar GPS). The operating frequency bands for GPS L1 and GPS L2 being listed below in Table 1 together with the frequency bands of the other major GNSS systems introduced in the 2000s, namely Beidou, Galileo, GLONASS, GPS, and NAVIC.

TABLE 1
Operating Frequencies of GNSS Systems (Nearest 1 MHz)

| System | Beidou | Galileo | GLONASS |
|---|---|---|---|
| Owner | China | Europe | Russia |
| Freq. | 1.559-1.563 GHz | 1.164-1.189 GHz | 1.593-1.610 GHz |
| | (B1) | (E5a) | (G1) |
| | 1.195-1.210 GHz | 1.189-1.214 GHz | 1.237-1.254 GHz |
| | (B2) | (E5b) | (G2) |
| | 1.256-1.280 GHz | 1.260-1.300 GHz | 1.189-1.214 GHz |
| | (B3) | (E6) | (G3) |
| | | 1.559-1.591 GHz | |
| | | (E1) | |

| System | GPS | NAVIC |
|---|---|---|
| Owner | USA | India |
| Freq. | 1.563-1.587 GHz (L1 signal) | 1.164-1.188 GHz (L5 Band) |
| | 1.215-1.2396 GHz (L2 signal) | 2.483-2.500 GHz (S Band) |
| | 1.164-1.189 GHz (L5 Band) | |

There is also increasing deployment of satellites which also provide a navigation signal on the L5 band and accordingly GNSS receivers compatible with the L1+L5 signals discretely or L1+L2+L5 signals. L5 offers several benefits including, but not limited to, twice as L2, being within a band designated by the International Telecommunication Union (ITU) for the Aeronautical Radio-Navigation Services (ARNS) which is less prone to interference with ground based navigation aids, and sharing the same frequency space as the E5A signal from Galileo. Similarly, there is benefit in having GNSS receivers compatible with the GPS and Galileo systems, for example, allowing a device comprising such a receiver to be employed in regions where one or both GNSS systems are accessible.

### Single-Band Stacked Low Elevation Angle Nulling Antenna

The underlying design concept of a low elevation angle nulling antenna (LEANA) is a radiating structure with a maximum gain at the zenith and a minimum gain at, or near, the horizon, the null around the horizon being around the entire azimuthal plane. In this manner radiating sources near the horizon have reduced interference to the GNSS system coupled to the LEANA.

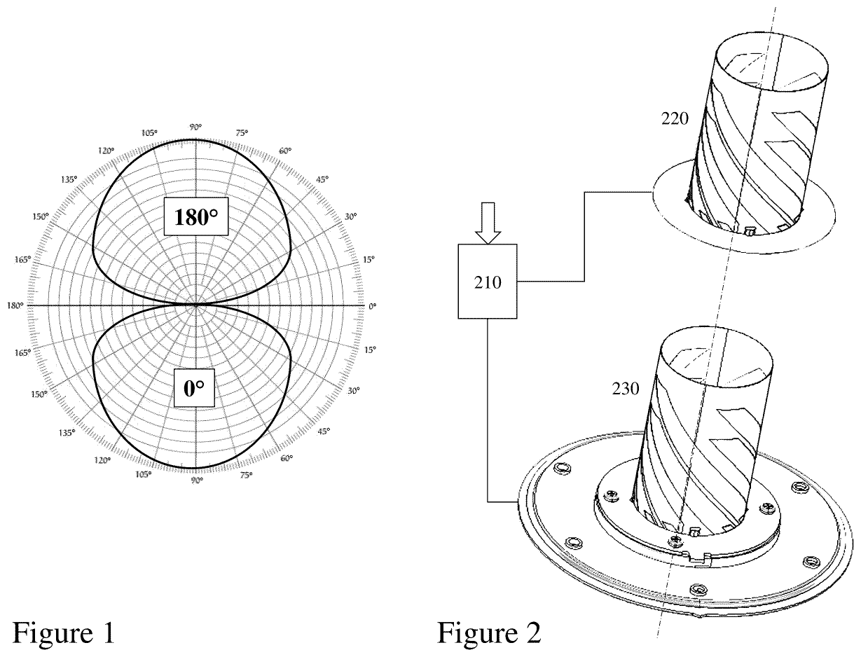

As depicted in FIG. 1 this can be achieved by applying antenna array theory and stacking a pair of antenna elements atop each other in the z-axis; the axis being the antenna's zenith. When this pair of antenna elements are fed in anti-phase with their separation distance being set to half a wavelength, the resultant superimposed radiation pattern is a strong gain at the zenith, due to constructive interference, and a strong null near the horizon, due to destructive interference.

For example, GNSS antennas are useful in timing applications, where a consistently reliable measure of absolute time, from the GNSS information, is required. Accordingly, increasing the reliability and preventing drops of the GNSS lock by minimizing the GNSS antenna's susceptibility to ground-based interference is beneficial in these applications. Accordingly, a single-band LEANA antenna can be used. The design of a single-band stacked antenna generally begins with the selection of a center frequency corresponding to the resonance frequency of an antenna. For example, AJ3000 antenna in Hautcoeur et al. “Anti-Jamming GNSS Antenna for Timing Applications” (18th International Symposium on Antenna Technology and Applied Electromagnetics, 2018, pp. 1-3), this selected frequency corresponds to the GPS L1 signal at 1575 MHz.

However, with a stacked antenna configuration, a challenge is the anti-phase feeding of both elements of the array. Conventionally, a coaxial transmission line (e.g. a cable) is used to provide the feed for the top antenna from the bottom antenna. However, the phase response through such a coaxial transmission line, to the top antenna, will vary with frequency. Whilst this phase response will still be linear it will have a different slope versus frequency. This limits the antenna to a narrowband of performance, typically for the upper GNSS band covering GPS L1.

However, as noted above many applications of GNSS antennas are broader band such as L1+L2 or L1+L5 or L1+L2+L5. Accordingly, the inventors have established a new LEANA implementation involving a phase manipulation technique to correct this varying phase response between the two antenna elements within the stacked pair.

### Phase Manipulation Technique

In order to understand the underlying concept of the phase response variation over frequency we consider the fundamental electrical concepts of wave propagation inside of a transmission line, or coaxial cable. Pozar in “Microwave Engineering” (Wiley Press) outlines the telegrapher equations derived from Maxwell's equations. These equations being a pair of coupled, linear partial differential equations that describe the voltage and current on an electrical transmission line with distance and time. These are used to compute the electromagnetic (EM) wave voltage and current over the length (z-axis) of the cable where the electromagnetic wave has properties of magnitude and, importantly, phase.

Consider an electromagnetic (EM) field travelling through a lossy transmission line. Equation (1) is the partial differential equation defining this EM field. The propagation constant is taken as γ=jω\sqrt{μϵ}=j2πf\sqrt{μϵ}. In this case, the electric field travelling through a coaxial cable in the z-axis, is given by E_{ρ}, being perpendicular to the z-axis.

$$\frac{{\partial }^{2} {E}_{ρ}}{\partial {z}^{2}} + {ω}^{2} μϵ {E}_{ρ} = 0 \qquad ( 1 )$$

It can be shown that the slope of the propagation constant, over frequency, is dependent on the material properties of the transmission line medium in Equation (2) where ω, the angular frequency, is given by 2πf. Extracting the propagation constant from Equation (1), and substituting the angular frequency, we get Equation (2).

$$\frac{\partial γ}{\partial f} = j 2 π \sqrt{μϵ} \qquad ( 2 )$$

Accordingly, the slope of the phase response through a transmission line is given by j2π\sqrt{μϵ}. As a lossy coaxial cable is required for any dual-band or triple-band LEANA, this difference in the phase slope between the phase of the top antenna and the phase of the bottom antenna is not only inevitable but a limitation without any mitigation. Accordingly, the inventors established a two-pronged approach to mitigate this phase slope difference.

### Multiband Implementation

Theoretically, to create a multi-band antenna with a null at the horizon using phased array theory, the two separate multi-band antenna elements are stacked atop each other in their zenithal axis half wavelength apart. Fed in antiphase, the superposition results in constructive interference at zenith, and destructive interference near horizon as depicted in FIG. 1.

However, as noted above and depicted in FIG. 2 the Top Antenna 220 and Bottom Antenna 230 are either each coupled to the external GNSS Circuitry 210 via coaxial cables or the Top Antenna 220 is fed from the Bottom Antenna 230. In either instance, the lossy cable or cables result in a LEANA with an uncontrollable phase response. This results in a phase slope difference, hence the antiphase feed that is sought will only be valid over a narrow bandwidth. This means a dual-band or triple-band antenna in this configuration is not possible, unless the phase slope of the bottom antenna can be controlled to match the phase slope leading into the top antenna.

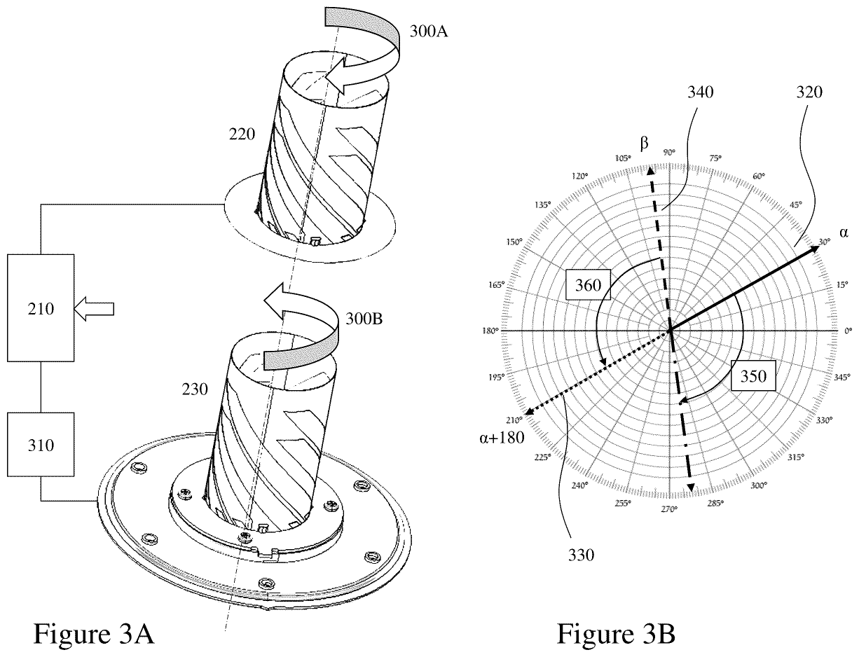

Accordingly, this controllable phase between the Top Antenna 220 and Bottom Antenna 230 can be achieved by using a discrete component transmission line as the feed into the bottom antenna element as depicted in FIG. 3A. Accordingly, as depicted the GNSS Circuitry 210 is coupled directly to the Top Antenna 220 and via a Phase Circuit 310 to the Bottom Antenna 230. However, it would be evident that the Phase Circuit 310 may be disposed in the path from the GNSS Circuitry 210 to the Top Antenna 220 and the Bottom Antenna 230 directly coupled to the GNSS Circuitry 210. Optionally, two different Phase Circuits may be disposed in each path from the GNSS Circuitry 210 to the Top Antenna 220 and Bottom Antenna 230 respectively.

A transmission line is approximated by a series inductor, L, along with its parasitic resistance R, and a shunt capacitor, C, along with its parasitic transconductance, G. Its propagation constant is given by Equation (3). For the purposes of discussion in order to simplify the mathematics, assuming lossless discrete components, i.e. setting R and G to zero, then Equation (3) becomes Equation (4) and the phase slope of the transmission line is given by Equation (5).

$$γ = \sqrt{( R + j ω L ) ( G + j ω C )} \qquad ( 3 )$$

$$γ = j ω \sqrt{LC} \qquad ( 4 )$$

$$\frac{\partial γ}{\partial f} = j 2 π \sqrt{LC} \qquad ( 5 )$$

$$μϵ = LC \qquad ( 6 )$$

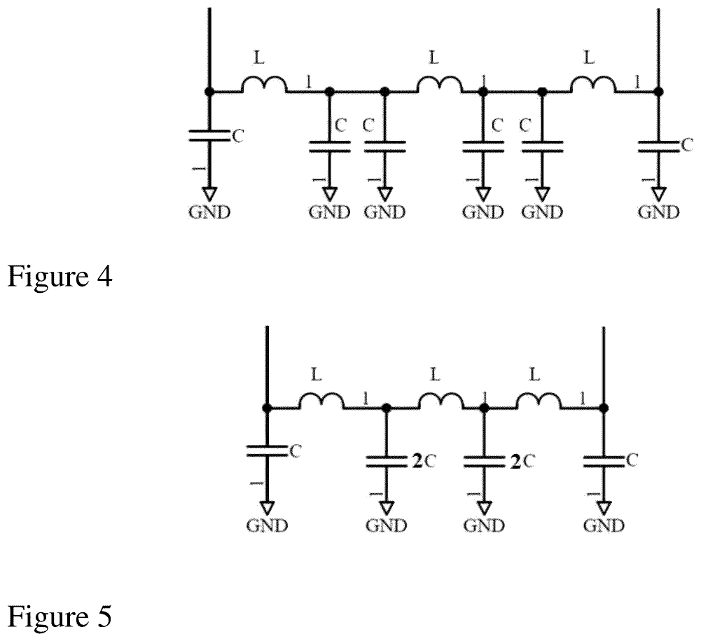

Accordingly, by using N-sections of discrete transmission line series inductor and shunt capacitor networks, the phase slope to the bottom of the antenna can be adjusted to match that of the top antenna, as per Equation (6). The left-hand side of Equation (6), therefore, is a constant, which depends upon on the coaxial cable being used, and the right-hand side is controlled, being the L and C components of each section of the transmission line. From analysis the inventors established that there was significant benefit to using more than a 3-section discrete transmission line, each section being a π (Pi) network. An exemplary schematic of a 3-section Pi network being depicted in FIG. 4.

By combining the inner capacitor pairs, the circuit depicted in FIG. 4 can be simplified to that of FIG. 5. Accordingly, by measuring the phase response of the coaxial cable to be employed within the stacked antenna pair, the values of the discrete components can be found, for example through use of an electronics simulator, so that the phase response through the circuit has the same slope as the phase response through the cable.

A typical constraint for the transmission line is that its characteristic impedance should be 50Ω to match the input and output components/circuits at its ends but it would be evident that other impedances may be employed without departing from the scope of the invention. The L and C components are therefore selected satisfy the target impedance requirement.

As the phase circuit compensates for only the phase slope difference, there will be an additional phase difference between the feed to the top antenna element, e.g. Top Antenna 220 in FIG. 3A, and the feed to the bottom element, e.g. Bottom Antenna 230 in FIG. 3A. This is due to the additional phase shift that is introduced by the compensation circuit, Phase Circuit 310 in FIG. 3A and as depicted in one implementation in FIG. 5. This would mean that both elements are no longer driven in antiphase.

However, this can be compensated by the rotation of the Top Antenna 220 in FIG. 3A relative to the Bottom Antenna 230 in FIG. 3A, this rotation being depicted by Rotation Arrow 300A, which compensates for this phase difference, phase offset, between the Top Antenna 220 and Bottom Antenna 230, thereby allowing a 180° phase difference between top and bottom elements to be achieved over the whole band of the antenna, e.g. dual-band coverage or triple-band coverage etc. Alternatively, the same compensation for this phase difference can be achieved by rotating the Bottom Antenna 230 relative to Top Antenna 220, this rotation being depicted by Rotation Arrow 300B. It would be evident that the direction of rotation for either rotating the Top Antenna 220 or the Bottom Antenna 230 may be the reverse of that shown. The magnitude of the rotation in either direction being dependent upon the phase angle offset of the wireless signals at the Top Antenna 220 and Bottom Antenna 230 as described and depicted with respect to FIG. 3B. Alternatively, both the Top Antenna 220 and Bottom Antenna 230 may be rotated rather than just one or the other.

Referring to FIG. 3B there is depicted a phase diagram of the system according to an embodiment of the invention depicted in FIG. 3A for visualizing the rotation applied between the stacked pair of quadrifilar helix antenna elements. Accordingly, first Indicator 320, at an angle of α°, represents the phase angle of wireless signals from/to the Top Antenna 220 in FIG. 3A from the GNSS Circuitry 210 via an electrical path between the GNSS Circuitry 210 and the Top Antenna 220. Second Indicator 330, at an angle of (α+180)°, represents the desired phase angle of wireless signals from/to the Bottom Antenna 230 such that the radiated wireless signals are 180° out of phase as described with respect to FIG. 1 to achieve the nulling at low elevations for the LEANA antenna comprising the Top Antenna 220 and Bottom Antenna 230 spaced apart physically by half wavelength.

However, as indicated by third Indicator 340, at an angle of β°, represents the resulting phase angle of wireless signals from/to the Bottom Antenna 230 from the GNSS Circuitry 210 via the another electrical path between the Bottom Antenna 230 from the GNSS Circuitry 210 which includes the Phase Circuit 310. Accordingly, the angle of β° of the wireless signals coupled to the Bottom Antenna 230 is not (α+180°) and the required nulling is not achieved as required for the LEANA. However, by rotating the Top Antenna 220 the angle α° is adjusted, as indicated by first Arrow 350, such that the wireless signals are offset by a phase difference of 180°. Alternatively, by rotating the Bottom Antenna 230 the angle β° is adjusted, as indicated by second Arrow 360, such that the wireless signals are offset by a phase difference of 180°. Alternatively, both the Top Antenna 220 and Bottom Antenna 230 may be rotated rather than just one or the other. Accordingly, the invention allows for the phase offsets arising from the electrical path, another electrical path and Phase Circuit 310 to be nulled out.

Within the description above the rotations are with respect of the antenna element(s) to the radiated or received wireless signals such that the desired nulling is achieved. The Phase Circuit 310 is provided such that the wireless signals to/from the Bottom Antenna 230 from/to the GNSS Circuitry 210 has the same phase versus frequency as the wireless signals to/from the Top Antenna 220 from/to the GNSS Circuitry 210 such that the rotational alignment for nulling operates over a wide band rather than being narrow band.

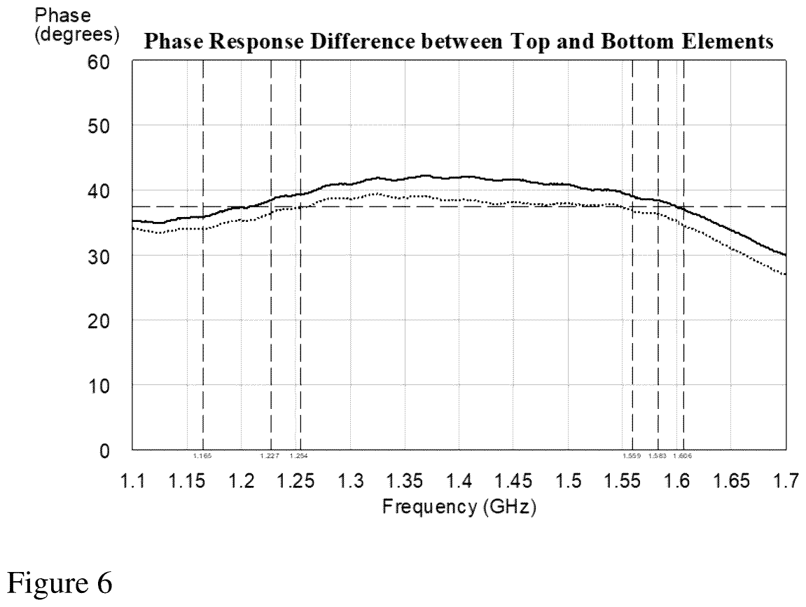

An exemplary result from a phase shift circuit according to an embodiment of the invention is depicted in FIG. 6 where the phase shift of the top antenna element and bottom antenna element, via the phase circuit. As evident the phase offset between the two elements is constant across the one, two or three bands of interest.

Whilst the embodiment of the invention described above has been described with respect to a coaxial cable, it would be evident that other electrical connection methodologies may be employed such as RF traces upon a substrate disposed between the pair of antenna elements without departing from the scope of the invention.

Whilst within embodiments of the invention the pair of antenna elements are depicted as colinear, which provides for omnidirectional nulling (radially symmetric) at low elevations, it would be evident that within other embodiments of the invention that whilst the axes of the pair of antenna elements may be parallel to a common axis they may be offset relative to one another. Such an offset results in the nulling not being radially symmetric, which may be beneficial in some instances to null essentially one side of an antenna only.

### Improved Flexible Antenna Assembly

The inventors have described within other patents GNSS antenna designs exploiting flexible carriers for thin film antenna elements, see for example, PCT/CA2020/051188 “GNSS Antenna Systems, Elements and Methods” and PCT/CA2022/051674 “Devices and Methods for Broadband Low Profile Antenna.” Referring to FIG. 8 there is depicted an upper perspective view of a GNSS antenna according to PCT/CA2020/051188 wherein an array of Petals 810 are mounted to a printed circuit board (PCB) 820 via tabs on the Petals 810 inserted into slots within the PCB 820.

The array of Petals 810 being formed upon a flexible substrate such as polyethylene terephthalate (PET), polyethylene naphthalate (PEN), polyimide (PI), liquid crystal polymers (LCPs), paper and polydimethylsiloxane (PDMS) for example. The Petals 810 being metallized traces upon the flexible substrate, such as copper (Cu) for example. Optionally, the Petals 810 may be free-standing metallized elements. Whilst the design depicted in FIG. 8 comprises eight (8) Petals 810 it would be evident that the number of Petals 810 may be other counts of N Petals 810 may be employed where N, the number of Petals 810, is an integer, generally an even integer.

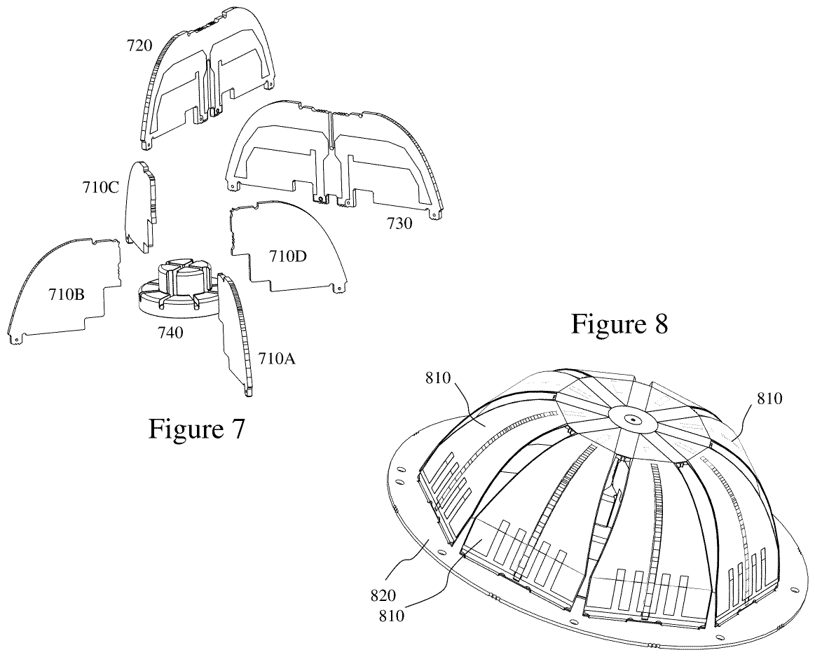

Now referring to FIG. 7 there is depicted a partially exploded assembly as deployed within a GNSS antenna according to PCT/CA2020/051188. The partially exploded assembly being within the flexible substrate comprising the array of Petals 810 as depicted in FIG. 8. As depicted in FIG. 7 there is a first Dipole A 720, a second Dipole B 730, first to fourth Supports 710A to 710D and Mounting Block 740. Evident on the Mounting Block 740 are the slots allowing insertion of the first Dipole A 720 and second Dipole B 730. Also evident are the slots for engaging the inner lower portions of the first to fourth Supports 710A to 710D respectively. In addition to providing a mechanical alignment of first Dipole A 720 and second Dipole B 730 the Mounting Block 740 also provides a benefit in the microwave/RF domain for performance of a GNSS antenna according to an embodiment of the invention. Each of the first Dipole A 720 and second Dipole B 730 are substrates, such as polytetrafluoroethylene (PTFE), a composite material composed of woven glass fabric surfaces and paper core (e.g. CEM-1), a glass mat and glass cloth composite substrate (e.g. CEM-3), a glass-reinforced epoxy laminate (e.g. FR-4), for example, with metallization, e.g. Cu, disposed upon it to provide RF dipoles. The two dipoles being orthogonal when assembled. The first to fourth Supports 710A to 710D being, for example, non-metallized substrates such as PTFE, CEM-1, CEM-2, CEM-3, FR4, FR-2, FR-3, FR-5, FR-6, G-10, CEM-4 and CEM-5 for example.

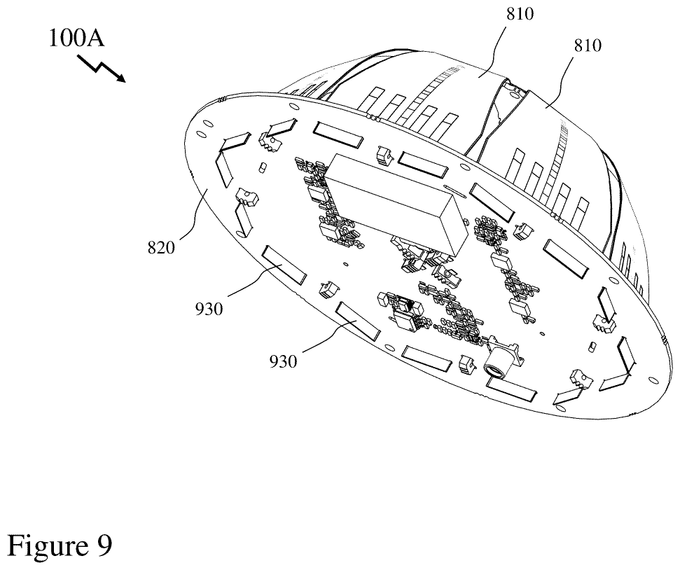

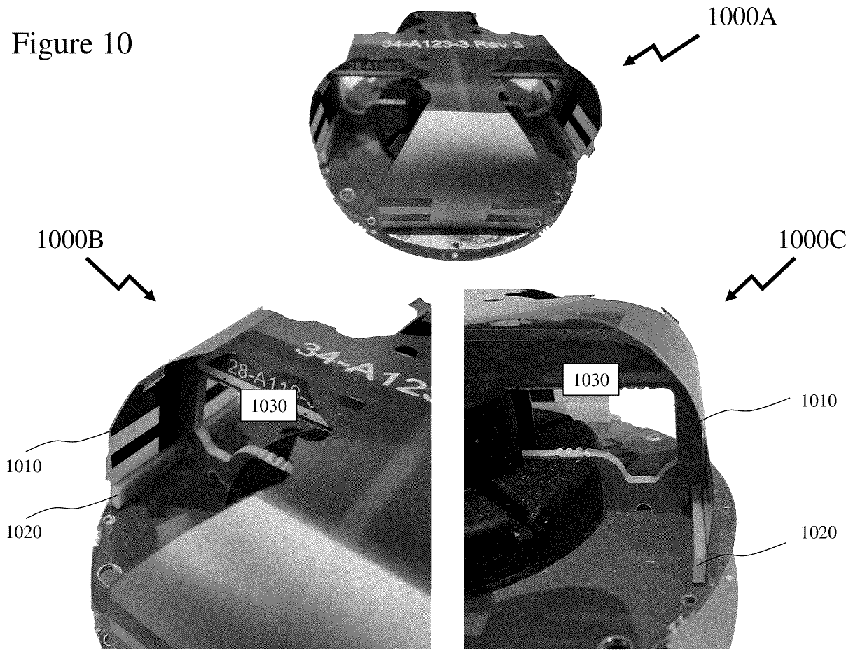

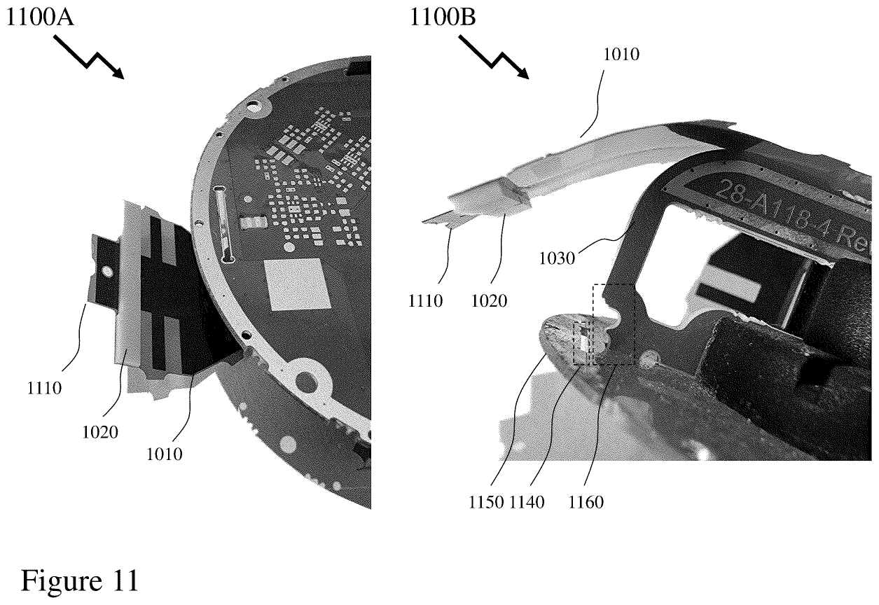

However, referring to FIG. 9, which is a lower perspective view of the GNSS antenna depicted in FIG. 8 wherein the Tabs 930 on the lower edge of each Petal 810 are evident through the PCB 820. Within the embodiment depicted in FIG. 9 each Petal 810 has a pair of Tabs 930. However, other embodiments such as depicted in FIGS. 10 and 11 may have a single tab. It would be evident that other numbers of tabs may be employed per petal or that a number of tabs may be associated with multiple tabs such that the number of tabs per petal may be integer or non-integer.

Referring to FIG. 10 there is depicted a GNSS Antenna 1000A employing the same design principles as that depicted in FIGS. 7 to 9 respectively with four petals, each pair of opposing petals associated with a dipole of the GNSS Antenna 1000A. Second and third Images 1000B and 1000C depict views of the GNSS Antenna 1000A showing a Substrate 1030, Petal 1010 and Support Element 1020. The Support Element 1020 mechanically engaging a Recess upon the lower external edge of the Substrate 1030.

FIG. 11 in first and second Images 1100A and 1100B respectively depict the GNSS Antenna 1000A in FIG. 10 partially assembled. Accordingly, the Substrate 1030, Petal 1010 and Support Element 1020 are depicted. Also evident is Tab 1110 which fits within Slot 1140 within the PCB 1150 of the GNSS Antenna. The Recess, Recess 1160, being evident in second Image 1100B. The dimensions of the Recess 1160 and the Support Element 1020 are defined such that a mechanical interference fit or snap type engagement is made when pressure is applied to the Support Element 1020 to engage it within the Recess 1160. In this manner, the flexible substate upon which the Petals 1010 are formed is retained in position. In this manner the flexible substate is retained either discretely without additional subsequent assembly process steps or subsequent assembly process steps, such as soldering the Tab 1110 to metallization on the lower side of the PCB 1150, can be performed easier.

Specific details are given in the above description to provide a thorough understanding of the embodiments of the invention. However, it is understood that the embodiments may be practiced without these specific details.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

What is claimed is:

1. A method comprising:
providing an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
providing the lower antenna element for the one of the receiving and transmitting another circularly polarized wireless signal within the predetermined frequency range, the lower antenna element comprising a second electrical interface which is coupled to the circuit via another electrical path; and
providing a phase circuit disposed within the another electrical path between the lower antenna element and the circuit; wherein
the circularly polarized wireless signal and another circularly polarized wireless signal are out of phase by 180° such that the antenna exhibits a maximum gain along the common axis and a minimum gain orthogonal to the common axis;
the phase circuit in combination with the another electrical path between the circuit and the lower antenna provides a phase change versus frequency at the second electrical interface equal to another phase change versus frequency at the first electrical interface; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

2. The method according to claim 1, wherein
the phase circuit comprises N π networks in series; and
N is an integer greater than or equal to 1.

3. The method according to claim 1, wherein
the upper antenna element is a helical antenna; and
the lower antenna element is a helical antenna.

4. The method according to claim 1, wherein
the upper antenna element is a helical quadrifilar antenna; and
the lower antenna element is a helical quadrifilar antenna.

5. The method according to claim 1, wherein
an axis of the upper antenna element is aligned with the common axis; and
an axis of the lower antenna element is aligned with the common axis.

6. An antenna comprising:
an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
the lower antenna element for the one of the receiving and transmitting another circularly polarized wireless signal within the predetermined frequency range, the lower antenna element comprising a second electrical interface which is coupled to the circuit via another electrical path; and
a phase circuit disposed within the another electrical path between the lower antenna element and the circuit; wherein
the circularly polarized wireless signal and another circularly polarized wireless signal operate in conjunction with each other such that the antenna exhibits a maximum gain along the common axis and a minimum gain orthogonal to the common axis;
the phase circuit in combination with the another electrical path between the circuit and the lower antenna provides a phase change versus frequency at the second electrical interface equal to another phase change versus frequency at the first electrical interface; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

7. The antenna according to claim 6, wherein
the phase circuit comprises N π networks in series; and
N is an integer greater than or equal to 1.

8. The antenna according to claim 6, wherein
the upper antenna element is a helical antenna; and
the lower antenna element is a helical antenna.

9. The antenna according to claim 6, wherein
the upper antenna element is a helical quadrifilar antenna; and
the lower antenna element is a helical quadrifilar antenna.

10. The antenna according to claim 6, wherein
an axis of the upper antenna element is aligned with the common axis; and
an axis of the lower antenna element is aligned with the common axis.

11. An antenna comprising:
an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
the lower antenna element for the one of the receiving and transmitting another circularly polarized wireless signal within the predetermined frequency range, the lower antenna element comprising a second electrical interface which is coupled to the circuit via another electrical path; and
a phase circuit disposed within the electrical path between the upper antenna element and the circuit; wherein
the circularly polarized wireless signal and another circularly polarized wireless signal operate in conjunction with each other such that the antenna exhibits a maximum gain along the common axis and a minimum gain orthogonal to the common axis;
the phase circuit in combination with the electrical path between the circuit and the upper antenna provides a phase change versus frequency at the first electrical interface equal to another phase change versus frequency at the second electrical interface; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

12. The antenna according to claim 11, wherein
the phase circuit comprises N π networks in series; and
N is an integer greater than or equal to 1.

13. The antenna according to claim 11, wherein
the upper antenna element is a helical antenna; and
the lower antenna element is a helical antenna.

14. The antenna according to claim 11, wherein
the upper antenna element is a helical quadrifilar antenna; and
the lower antenna element is a helical quadrifilar antenna.

15. The antenna according to claim 11, wherein
an axis of the upper antenna element is aligned with the common axis; and
an axis of the lower antenna element is aligned with the common axis.

16. An antenna comprising:
an upper antenna element for receiving or transmitting a circularly polarized wireless signal within a predetermined frequency range disposed above a lower antenna element along a common axis with the lower antenna element, the upper antenna element comprising a first electrical interface which is coupled to a circuit via an electrical path;
the lower antenna element for the one of the receiving and transmitting another circularly polarized wireless signal within the predetermined frequency range, the lower antenna element comprising a second electrical interface which is coupled to the circuit via another electrical path; and
a first phase circuit disposed within the electrical path between the upper antenna element and the circuit; and
a second phase circuit disposed within the another electrical path between the lower antenna element and the circuit; wherein
the circularly polarized wireless signal and another circularly polarized wireless signal operate in conjunction with each other such that the antenna exhibits a maximum gain along the common axis and a minimum gain orthogonal to the common axis;
the first phase circuit in combination with the electrical path between the circuit and the upper antenna provides a phase change versus frequency at the first electrical interface that is equivalent to another phase change versus frequency at the second electrical interface established by the second phase circuit in combination with the another electrical path; and
the lower antenna element and upper antenna element are rotationally offset with respect to one another where the rotational offset is established in dependence upon the absolute phase difference between the circularly polarized wireless signal at the first electrical interface and the another circularly polarized wireless signal at the second electrical interface.

17. The antenna according to claim 16, wherein
the phase circuit comprises N π networks in series; and
N is an integer greater than or equal to 1.

18. The antenna according to claim 16, wherein
the upper antenna element is a helical antenna; and
the lower antenna element is a helical antenna.

19. The antenna according to claim 16, wherein
the upper antenna element is a helical quadrifilar antenna; and
the lower antenna element is a helical quadrifilar antenna.

20. The antenna according to claim 16, wherein
an axis of the upper antenna element is aligned with the common axis; and
an axis of the lower antenna element is aligned with the common axis.
